(19) United States
(12) Patent Application Publication
(10) Pub. No.: US 2015/0325193 A1
(43) Pub. Date: Nov. 12, 2015

(54) Method for Source Driving Circuit and Display Device Thereof

(71) Applicant: NOVATEK Microelectronics Corp., Hsin-Chu (TW)

(72) Inventors: Shu-Wei Chang, New Taipei City (TW); Chia-Chi Yu, Hsinchu County (TW); Kuo-Jen Hsu, Hsinchu County (TW)

(21) Appl. No.: 14/331,235

(22) Filed: Jul. 15, 2014

(30) Foreign Application Priority Data
May 6, 2014 (TW) 103116120

(51) Int. Cl. G09G 3/36

(52) U.S. Cl. CPC G09G 3/3688; G09G 3/3648; G09G 2300/0809; G09G 2300/0413; G09G 2310/027; G09G 2340/0407

(57) ABSTRACT

A method for a source driving circuit utilized in a display device includes receiving an input signal by a first reception module at a first period, receiving the input signal by the first reception module and a second reception module at a second period after the first period, receiving the input signal by the second reception module and a third reception module at a third period after the second period, and outputting the input signal received by the first reception module, the second reception module and the third reception module to a display panel after the third reception module finishes reception of the input signals, wherein the second reception module is disposed between the first reception module and the third reception module.

### BACKGROUND OF THE INVENTION

1. Field of the Invention

The present invention relates to a method and a display device for controlling a source driving circuit of the display device, and more particularly, to a method and a display device for adaptively adjusting a display device resolution to control a source driving circuit of the display device.

2. Description of the Prior Art

Conventionally, a display device such as a liquid crystal display (LCD) device, comprises a plurality of pixel units where each pixel unit is a metal-oxide semiconductor (MOS) transistor to be simultaneously coupled to a gate driving circuit and a source driving circuit. Via a gate control signal and a source control signal generated by the gate driving circuit and the source driving circuit, respectively, each MOS transistor is correspondingly turned on/off. A timing controller is coupled to the gate driving circuit and the source driving circuit to correspondingly control generation periods of the gate control signal and the source control signal, so as to control a conduction period of each MOS transistor, such that information transmitted by the source driving circuit can be displayed on the display device as a display information. The number of the pixel units (or sub pixel units) is determined by the maximum resolution of the display device, and accordingly, the connection of the gate driving circuit and the source driving circuit can be adaptively adjusted.

Noticeably, when a processing module, such as a digital signal processer, is applied with different display devices, and the pin numbers of each display device and the processing module are different, e.g. the pin number of the processing module is 1280 and the pin number of the display device is 960. Accordingly, 320 extra pins of the processing module, i.e. 1280−960=320, each can be set as a dummy channel, which means that 320 MOS transistors of the processing module each is set as the dummy channel, and generally, all of them are connected as short circuit. Under such circumstances, those MOS transistors predetermined as the dummy channels continuously receive dummy data, such as high-level signals, for effectively reducing a resolution corresponding to the display information. Also, the display information can be functionally displayed on the display device while the display device is operated with different resolutions of the display information. The jumper wire is the common realization of the dummy channel, i.e. some MOS transistors directly coupled to the source driving circuit are the short circuit, such that the MOS transistors being set as the dummy channels can be skipped while driving all the MOS transistors.

By utilizing the jumper wires realization of the dummy channel, it can be impossible for the designer to know in advance which part of the MOS transistors are predetermined to be coupled to the dummy channels. When the display information are reversed from left to right in comparison with the original display information, the corresponding MOS transistors are possible to receive the inappropriate display information for display. Accordingly, the designer must instruct/notify the display device which part of the MOS transistors are predetermined as the dummy channels, and a control circuit is utilized to transmit the dummy information for those MOS transistors, such that the digital signal processor can functionally display the display information. However, the designer may not possibly know in advance changes/differences of the display device resolution in order to preset/modify the number or positions of the dummy channel(s). For being capable of switching between different display device resolutions, the designer may add other determination mechanisms/complex circuit designs to cooperate with the digital signal processor, which results in less population/application of the display device.

Therefore, it has become an important issue to provide a more efficient driving method and display device for controlling the source driving circuit which can adaptively cooperate with different display devices for enhancing their capabilities of switching between different display device resolutions.

### SUMMARY OF THE INVENTION

It is therefore an objective of the invention to provide a method and a display device for adaptively adjusting a display device resolution to control a source driving circuit of the display device.

An embodiment of the invention discloses a method for controlling a source driving circuit utilized in a display device and comprises a first reception module, a second reception module and a third reception module. The method comprises receiving an input signal by the first reception module at a first period; receiving the input signal by the first reception module and the second reception module at a second period after the first period; receiving the input signal by the second reception module and the third reception module at a third period after the second period; and outputting the input signal received by the first reception module, the second reception module and the third reception module to a display panel after the third reception module has received the input signal; wherein the second reception module is disposed between the first reception module and the third reception module, each of the first reception module, the second reception module and the third reception module comprises a plurality of transistors to receive the input signal, and the input signal corresponds to a display information of the display device.

An embodiment of the invention also discloses another control chip coupled to a gate driving circuit and a source driving circuit, the source driving chip comprises a first reception module, a second reception module and a third reception module. The control chip comprises a storage device, for storing a programming code, wherein the programming code is utilized to instruct a method for controlling the source driving circuit. The method comprises receiving an input signal by the first reception module at a first period; receiving the input signal by the first reception module and the second reception module at a second period after the first period; receiving the input signal by the second reception module and the third reception module at a third period after the second period; and outputting the input signal received by the first reception module, the second reception module and the third reception module to a display panel after the third reception module has received the input signal; wherein the second reception module is disposed between the first reception module and the third reception module, each of the first reception module, the second reception module and the third reception module comprises a plurality of transistors to receive the input signal, and the input signal corresponds to a display information of the display device.

An embodiment of the invention also discloses another display device which comprises a display panel; a gate driving circuit, coupled to the display panel; a source driving circuit, coupled to the display panel, comprising a first reception module, a second reception module and a third reception module; and a control chip, coupled to the gate driving circuit and the source driving circuit, comprising a storage device for storing a programming code, wherein the programming code is utilized to instruct a method for controlling the source driving circuit. The method comprises receiving an input signal by the first reception module at a first period; receiving the input signal by the first reception module and the second reception module at a second period after the first period; receiving the input signal by the second reception module and the third reception module at a third period after the second period; and outputting the input signal received by the first reception module, the second reception module and the third reception module to a display panel after the third reception module has received the input signal; wherein the second reception module is disposed between the first reception module and the third reception module, each of the first reception module, the second reception module and the third reception module comprises a plurality of transistors to receive the input signal, and the input signal corresponds to a display information of the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a display device according to an embodiment of the invention.

FIG. 2 illustrates a detailed schematic diagram of a source driving circuit of the display device shown in FIG. 1.

FIG. 3 illustrates a schematic diagram of another display device according to an embodiment of the invention.

FIG. 4 illustrates a flow chart of a driving process according to an embodiment of the invention.

FIG. 5 illustrates a schematic diagram of operations of one step of the driving process shown in FIG. 4 to be applied to the display device according to an embodiment of the invention.

FIG. 6 illustrates a schematic diagram of operations of one step of the driving process shown in FIG. 4 to be applied to the display device according to an embodiment of the invention.

FIG. 7 illustrates a schematic diagram of operations of one step of the driving process shown in FIG. 4 to be applied to the display device according to an embodiment of the invention.

FIG. 8 illustrates a schematic diagram of operations of one step of the driving process shown in FIG. 4 to be applied to the display device according to an embodiment of the invention.

FIG. 9 illustrates a schematic diagram of operations of one step of the driving process shown in FIG. 4 to be applied to the display device according to an embodiment of the invention.

FIG. 10 illustrates a schematic diagram of operations of one step of the driving process shown in FIG. 4 to be applied to the display device according to an embodiment of the invention.

FIG. 11 illustrates a schematic diagram of another display device to be applied to one step of the driving process shown in FIG. 4 according to an embodiment of the invention.

FIG. 12 illustrates a schematic diagram of operations of one step of the driving process shown in FIG. 4 to be applied to the display device shown in FIG. 11 according to an embodiment of the invention.

FIG. 13 illustrates a schematic diagram of operations of one step of the driving process shown in FIG. 4 to be applied to the display device shown in FIG. 11 according to an embodiment of the invention.

FIG. 14 illustrates a schematic diagram of operations of one step of the driving process shown in FIG. 4 to be applied to the display device shown in FIG. 11 according to an embodiment of the invention.

FIG. 15 illustrates a schematic diagram of operations of one step of the driving process shown in FIG. 4 to be applied to the display device shown in FIG. 11 according to an embodiment of the invention.

### DETAILED DESCRIPTION

The specification and the claims of the present invention may use a particular word to indicate an element, which may have diversified names named by distinct manufacturers. The present invention distinguishes the element depending on its function rather than its name. The phrase “comprising” used in the specification and the claims is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

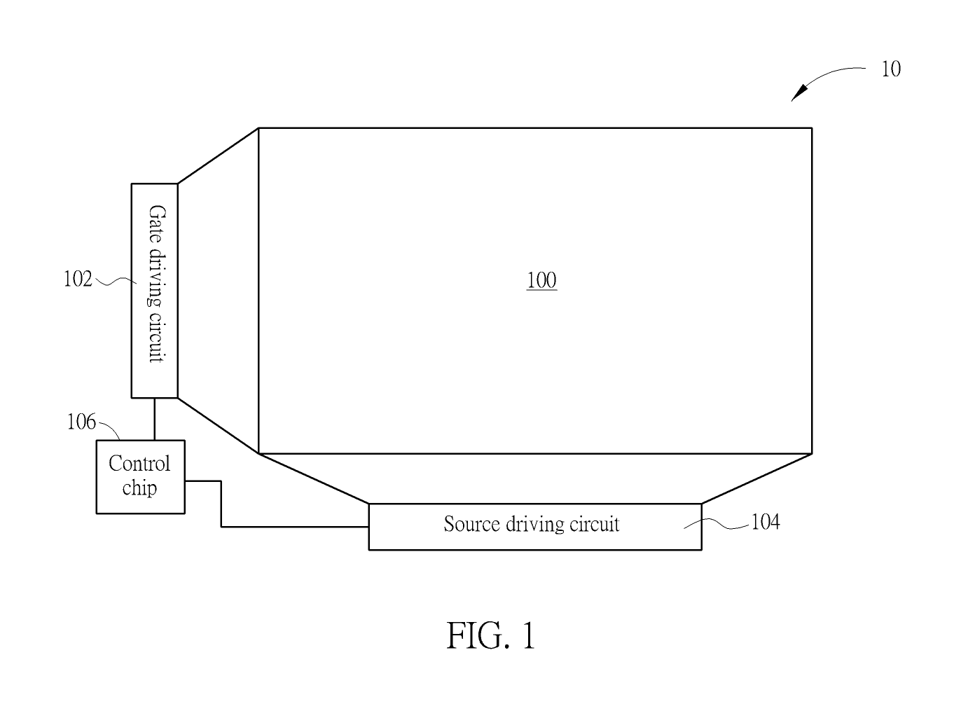

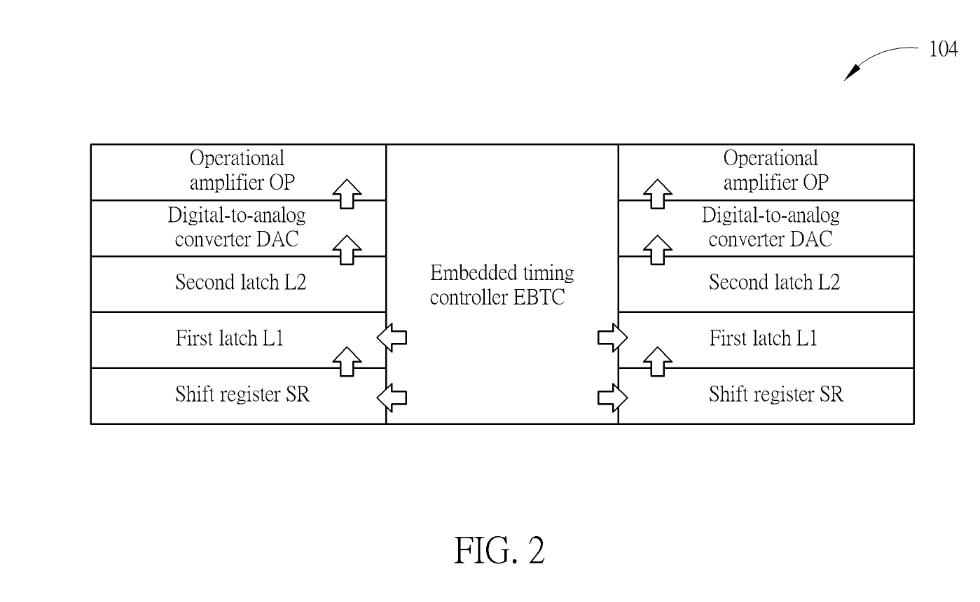

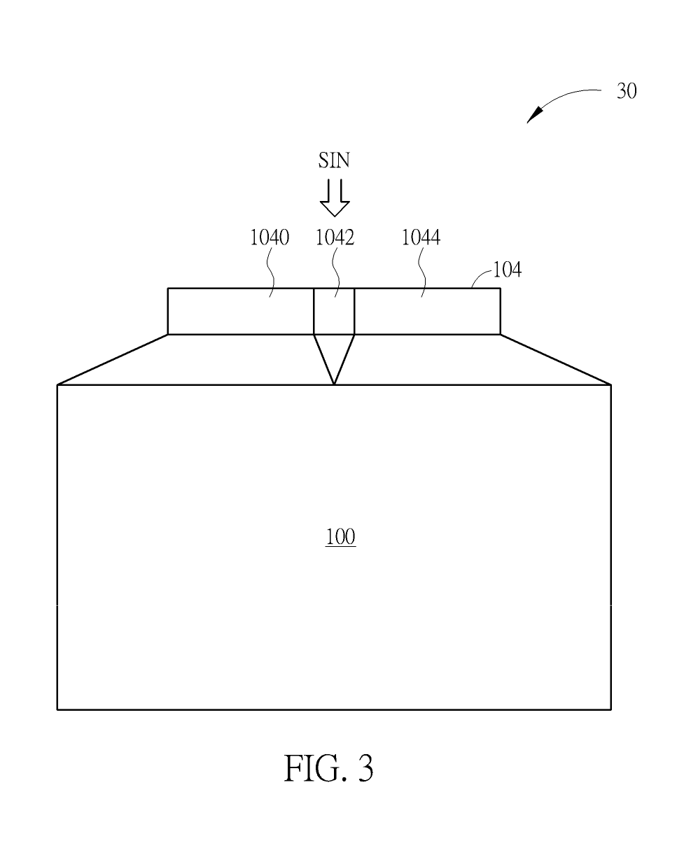

FIG. 1 illustrates a schematic diagram of a display device 10 according to an embodiment of the invention. FIG. 2 illustrates a detailed schematic diagram of a source driving circuit 104 of the display device 10 shown in FIG. 1. As shown in FIG. 1, the display device 10 comprises a display panel 100, a gate driving circuit 102, a source driving circuit 104 and a control chip 106. As shown in FIG. 2, the source driving circuit 104 of the embodiment comprises an embedded timing controller EBTC, and symmetrically comprises a pair of shift registers SR, a pair of first latches L1, a pair of second latches L2, a pair of digital-to-analog converters DAC and a pair of operational amplifiers OP. In the embodiment, the embedded timing controller EBTC generates a timing control signal to the shift registers SR and the first latches L1. Also, the source driving circuit 104 is controlled by the control chip 106 to correspondingly receive a display information of the display device 10. After operations of the second latches L2, digital-to-analog converters DAC and operational amplifiers OP, the display information is transmitted to the display panel 100. Besides, the control chip 106 of the embodiment also comprises a storage device (not shown in the figure) to store a programming code, which is utilized to process a method for controlling the source driving circuit 104. In order to clarify the main point of the invention, another simplified schematic diagram of a display device 30 is shown in FIG. 3 according to an embodiment of the invention, i.e. the display device is are depicted to comprise the display panel 100 and the source driving circuit 104, and the source driving circuit 104 comprises a first reception module 1040, a second reception module 1042 and a third reception module 1044. According to controlling of the programming code in the control chip 106, the first reception module 1040, the second reception module 1042 and the third reception module 1044 respectively receive an input signal SIN at different periods.

The source driving circuit 104 of the embodiment sequentially arranges the first reception module 1040, the second reception module 1042 and the third reception module 1044 from left to right, and the second reception module 1042 is disposed between the first reception module 1040 and the third reception module 1042. The user can reverse the positions of the first reception module 1040 and the third reception module 1042, such that the source driving circuit 104 sequentially arranges the third reception module 1042, the second reception module 1042 and the first reception module 1040 from left to right, which is not limiting the scope of the invention. Additionally, the source driving circuit 104 of the embodiment comprises a plurality of transistors, which means that the first reception module 1040, the second reception module 1042 and the third reception module 1044 are realized via a plurality of transistors. Due to the controlling of the programming code of the control chip 106, the input signal SIN is sequentially received by the plurality of transistors of the first reception module 1040, the second reception module 1042 and the third reception module 1044, respectively. After all the transistors have received the input signal SIN, the input signal SIN will be transmitted to the display panel 100 for display.

Preferably, a total number of the plurality of transistors of the first reception module 1040, the second reception module 1042 and the third reception module 1044 is an original display device resolution, and a total number of the plurality of transistors of the first reception module 1040 and the third reception module 1044 is a corrective display device resolution, wherein a number of the transistors of the second reception module 1042 is a dummy channel number. Under such circumstances, the user can modify the number of the transistors of the second reception module 1042 for the display device 30 to be switched between different display device resolutions. In addition, a driving method of the display panel 100 to be cooperated with the gate driving circuit 102 and the source driving circuit 104 should be well known to those skilled in the art, so as to adaptively turn on/off the plurality of pixel units (not shown in the figure) of the display panel 100, which is not described herein for brevity.

Simply, the source driving circuit 104 of the embodiment is divided into three transistor groups from left to right, such as the first reception module 1040, the second reception module 1042 and the third reception module 1044. The dummy channels corresponding to the plurality of transistors of the second reception module 1042 are initially driven to receive the input signal SIN within a driving period, or are skipped within the driving period. The first reception module 1040 and the third reception module 1044 sequentially receive the input signal SIN within another driving period. Once the first reception module 1040 of the source driving circuit 104 receives the input signal SIN, the plurality of transistors of the second reception module 1042 are ready to receive the input signal SIN, or the plurality of transistors of the second reception module 1042 are skipped for not receiving the input signal SIN. Till the third reception module 1044 has received the input signal SIN, the plurality of transistors of the second reception module 1042 will correspondingly finish the operations of receiving the input signal SIN or to be skipped, which is the scope of the invention. Preferably, the driving period of the second reception module 1042 is smaller than the driving periods of the first reception module 1040 and the third reception module 1044, which means that the driving period of the second reception module 1042 overlaps/synchronizes a sum of the driving periods of the first reception module 1040 and the third reception module 1044. Certainly, those skilled in the art can adaptively modify/design the mentioned driving periods of the first/second/third reception module, i.e. each driving period can be divided into a plurality of sub-driving periods, such that the plurality of the transistors of the second reception module 1042 can finish the related operations within different sub-driving periods thereof. Also, the sub-driving periods of the plurality of transistors of the first reception module 1040 and the third reception module 1042 can synchronize the sub-driving periods of the second reception module 1042 to finish the reception/skipping operations of the transistors, which is also in the scope of the invention.

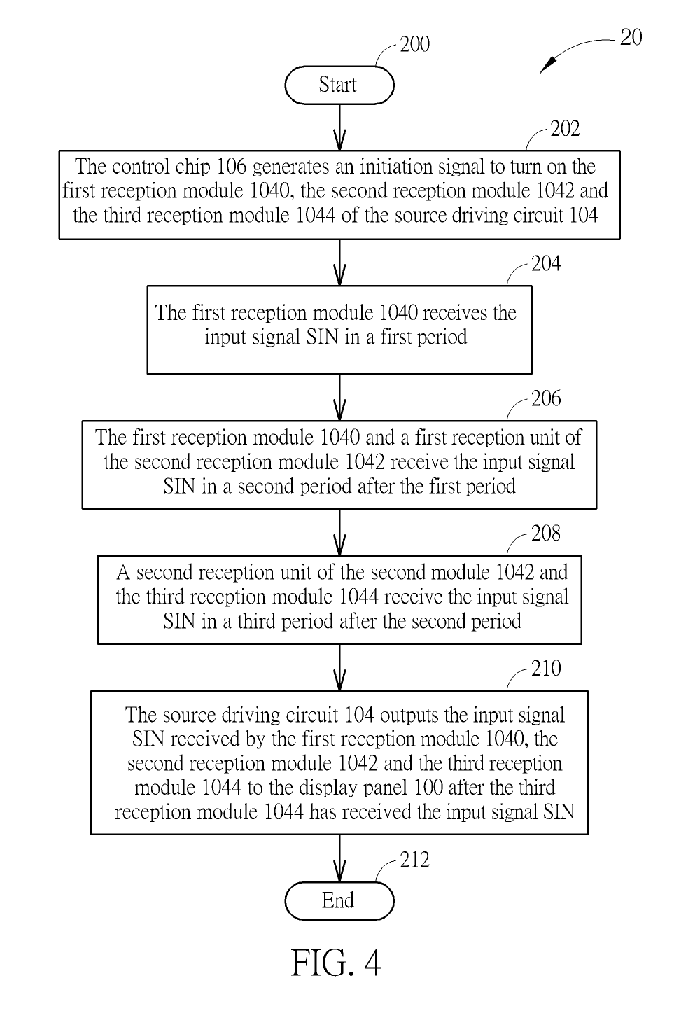

Preferably, the programming code in the control chip 106 to instruct the method for controlling the source driving circuit 104 can be summarized as a driving process 20, as shown in FIG. 4. The driving process 20 includes the steps as follows:

Step 200: Start.

Step 202: The control chip 106 generates an initiation signal to turn on the first reception module 1040, the second reception module 1042 and the third reception module 1044 of the source driving circuit 104.

Step 204: The first reception module 1040 receives the input signal SIN in a first period.

Step 206: The first reception module 1040 and a first reception unit of the second reception module 1042 receive the input signal SIN in a second period after the first period.

Step 208: A second reception unit of the second module 1042 and the third reception module 1044 receive the input signal SIN in a third period after the second period.

Step 210: The source driving circuit 104 outputs the input signal SIN received by the first reception module 1040, the second reception module 1042 and the third reception module 1044 to the display panel 100 after the third reception module 1044 has received the input signal SIN.

Step 212: End.

In the embodiment, the first period, the second period and the third period correspond to the driving periods of the plurality of transistors of the first reception module 1040, the second reception module 1042 and the third reception module 1044, respectively. During switching between the display device resolutions, the user can adaptively set the number of the transistors of the second reception module 1042. Preferably, the number of the transistors of the second reception module 1042 is smaller than the number of the transistors of the first reception module 1040 and the third reception module 1044. In other words, the second period is shorter than the first period/third period. According to the original display device resolution and the corrective display device resolution, the number of the transistors of the second reception module 1042 can be adaptively modified/adjusted (i.e. correspondingly adjusting the number of the dummy channels), such that the number of the transistors of the second reception module 1042 is not smaller than the number of the transistors of the first reception module 1040/third reception module 1044, which is also the scope of the invention.

In step 202, the control chip 106 is controlled via a timing controller (not shown in the figure) to transmit the initiation signal to the source driving circuit 104, so as to turn on the first reception module 1040, the second reception module 1042 and the third reception module 1044 of the source driving circuit 104 for the reception of the input signal SIN.

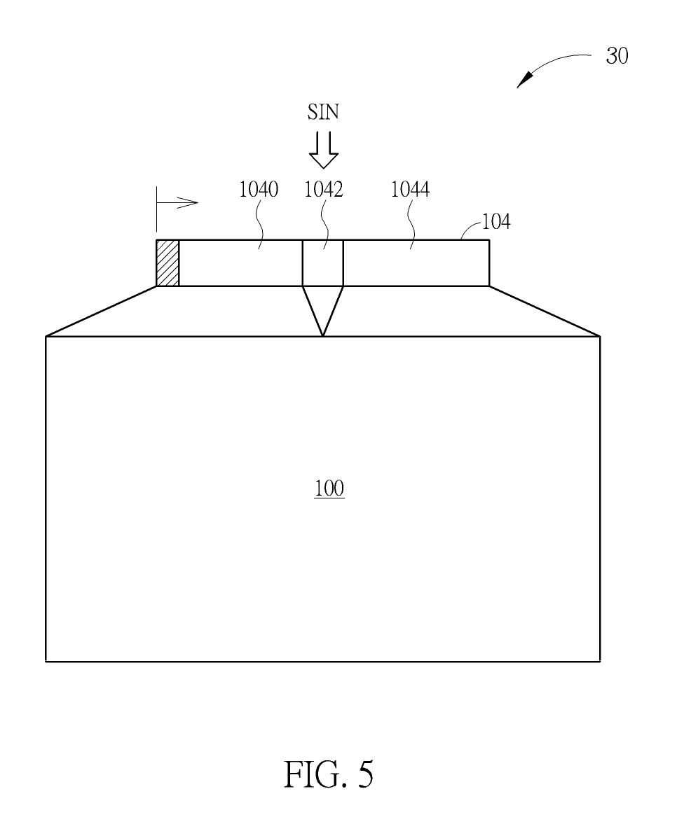

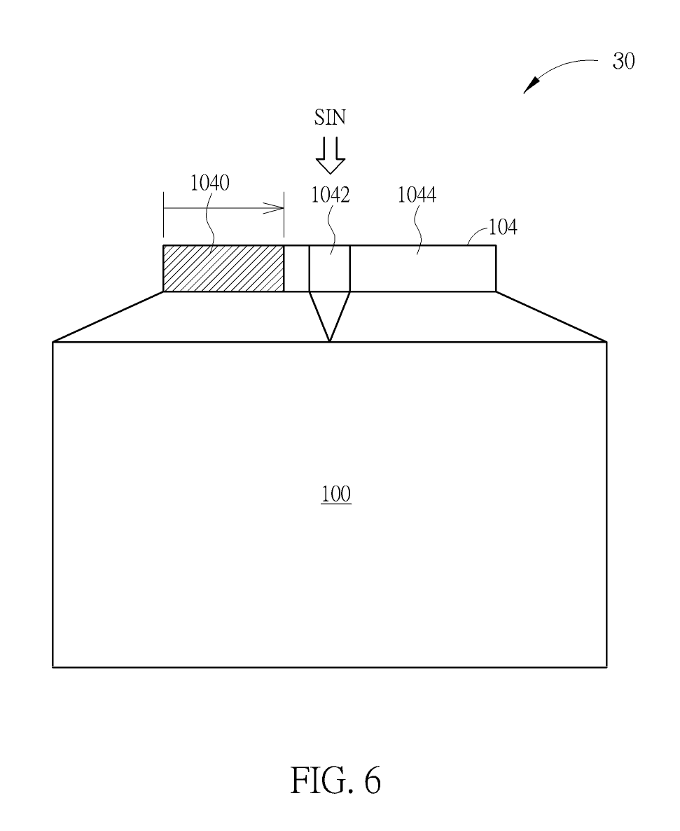

Please refer to FIG. 5, which illustrates a schematic diagram of operations of step 204 of the driving process 20 to be applied to the display device 30 according to an embodiment of the invention. As shown in FIG. 5, in step 204, the plurality of transistors of the first reception module 1040 sequentially receive the input signal SIN from left to right within the first period, wherein the plurality of transistors of the first reception module 1040 having received the input signal SIN are marked with oblique lines. FIG. 6 illustrates a schematic diagram of an ending of step 204 of the driving process 20 to be applied to the display device 30 according to an embodiment of the invention. As shown in FIG. 6, after the first period, some of the plurality of transistors of the first reception module 1040 being marked with the oblique lines have finished the reception of the input signal SIN, and the other transistors of the first reception module 1040 have not received the input signal SIN.

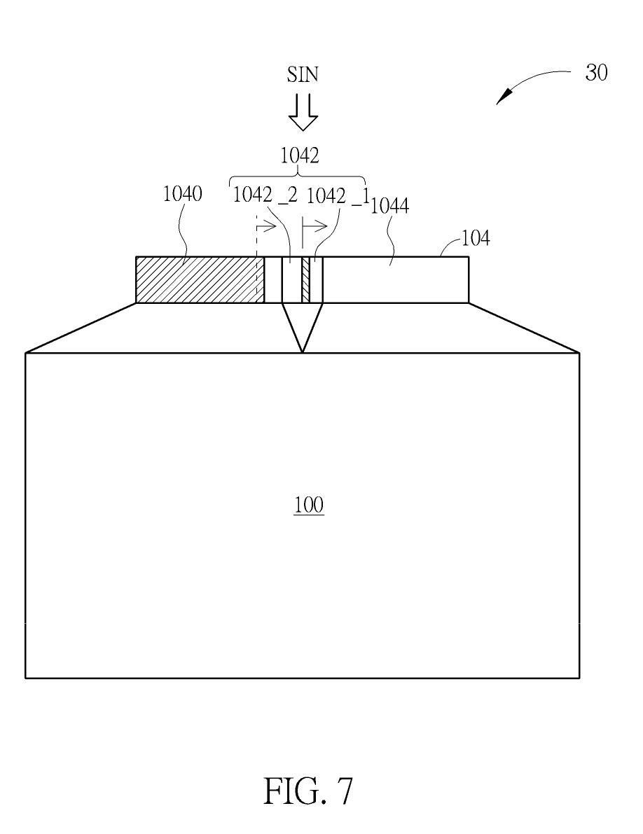

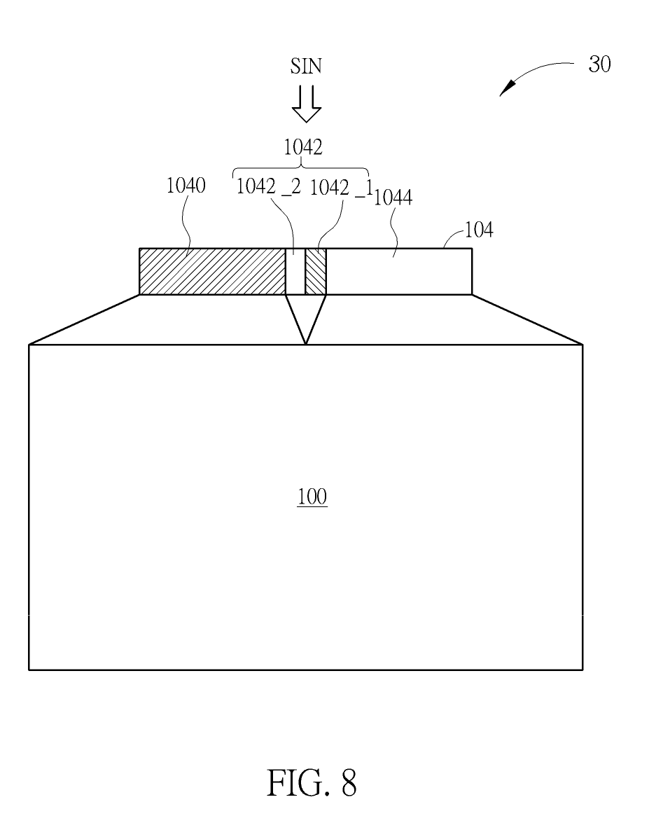

Please refer to FIG. 7, which illustrates a schematic diagram of operations of step 206 of the driving process 20 to be applied to the display device 30 according to an embodiment of the invention. As shown in FIG. 7, in step 206, after the first period, the first reception module 1040 continuously receives the input signal SIN, and the second reception module 1042 starts to receive the input signal SIN within the second period. In detail, the plurality of transistors of the second reception module 1042 are divided into two groups, such as the first reception unit 1042_1 and the second reception unit 1042_2. Within the second period and after the first period, the transistors of the first reception module 1040 having not received the input signal SIN start to receive the input signal SIN, and the first reception unit 1042_1 of the second reception module 1042 also starts to receive the input signal SIN, but the second reception unit 1042_2 of the second reception module 1042 does not start to receive the input signal SIN. Preferably, the number of the plurality of transistors of the first reception module 1040 having not received the input signal SIN equals to the number of the transistors of the first reception unit 1042_1, such that the transistors of the first reception module 1040 and the second reception module 1042 synchronously receive the input signal SIN. FIG. 8 illustrates a schematic diagram of an ending of step 206 of the driving process 20 to be applied to the display device 30 according to an embodiment of the invention. As shown in FIG. 8, after the second period, the plurality of transistors of the first reception module 1040 have received the input signal SIN, and the first reception unit 1042_1 of the second reception module 1042 have received the input signal SIN. Besides, while the plurality of transistors of the first reception module 1040 are receiving the input signal SIN, the first reception unit 1042_1 of the embodiment can be designed not to receive the input signal SIN. Alternatively, the plurality of transistors of the first reception unit 1042_1 can be correspondingly skipped to prepare other transistors for related driving operations, which is also in the scope of the invention. Under such circumstances, the plurality of transistors having received the input signal SIN of the first reception module 1040 and the second reception module 1042 are also marked with the oblique lines, or the plurality of transistors being skipped of the first reception unit 1042_1 are marked with the oblique lines as well.

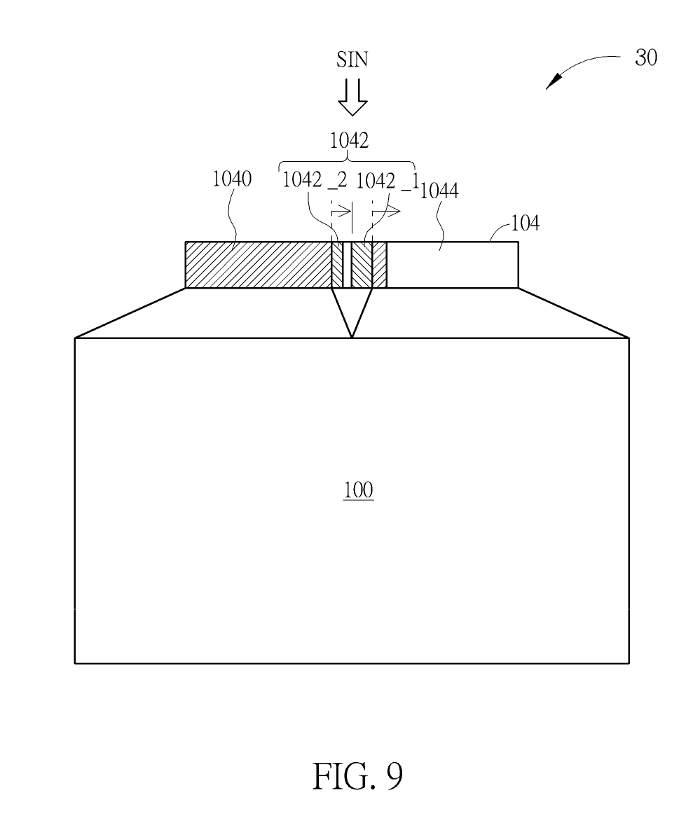

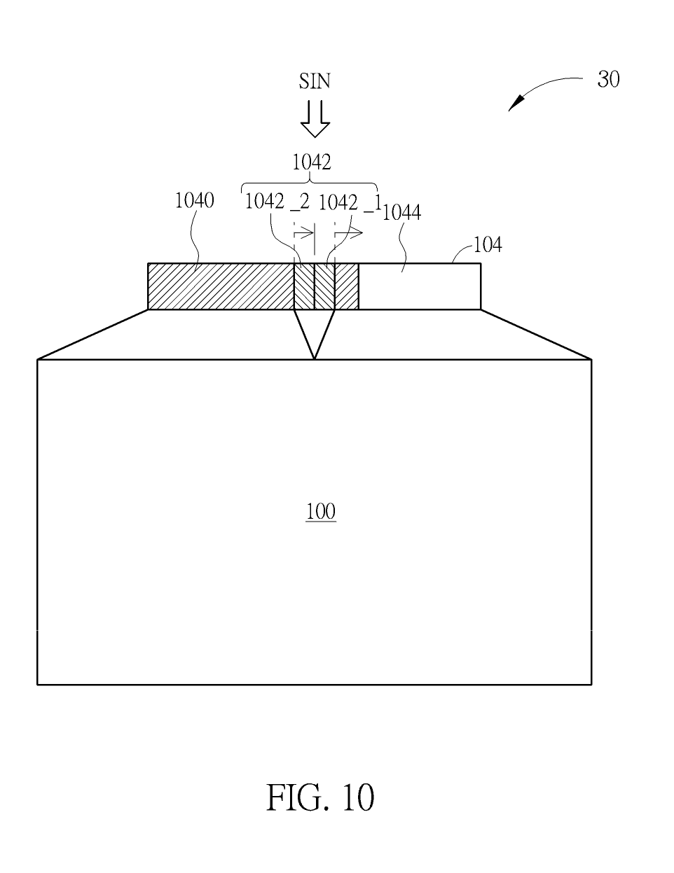

Please refer to FIG. 9, which illustrates a schematic diagram of operations of step 208 of the driving process 20 to be applied to the display device 30 according to an embodiment of the invention. As shown in FIG. 9, in step 208, after the second period, the second reception unit 1042_2 of the second reception module 1042 and the third reception module 1044 start to receive the input signal SIN within the third period. The second reception unit 1042_2 of the embodiment can be designed not to receive the input signal SIN, and to correspondingly skip the plurality of transistors of the second reception unit 1042_2, so as to prepare other transistors for related driving operations, which is also in the scope of the invention. FIG. 10 illustrates a schematic diagram of an ending of step 208 of the driving process 20 to be applied to the display device 30 according to an embodiment of the invention. As shown in FIG. 10, after the third period, the second reception unit 1042_2 of the second reception module 1042 have received the input signal SIN (or the corresponding transistors of the second reception unit 1042_2 are skipped), and some of the transistors of the third reception module 1044 have received the input signal SIN, wherein the plurality of transistors having received the input signal SIN of the second reception unit 1042_2 of the second reception module 1042 and the third reception module 1044 are also marked with the oblique lines, or the plurality of transistors being skipped of the second reception unit 1042_2 are marked with the oblique lines as well. Preferably, the number of the transistors of the third reception module 1044 having received the input signal SIN equals the number of the transistors of the second reception unit 1042_2 of the second reception module 1042, such that the transistors of the third reception module 1044 and the second reception unit 1042_2 of the second reception module 1042 synchronously receive the input signal SIN, or the transistors of the third reception module 1044 receive the input signal SIN and the transistors of the second reception unit 1042_2 of the second reception module 1042 are correspondingly skipped, which is also the scope of the invention.

Lastly, in step 210, after the third reception module 1044 has received the input signal SIN, the source driving circuit 104 of the embodiment outputs the received input signal SIN of the first reception module 1040, the second reception module 1042 and the third reception module 1044 together to the display panel 100 for display. The user can wait a predetermined period after the third period to have the source driving circuit 104 output the received input signal SIN of the first reception module 1040, the second reception module 1042 and the third reception module 1044 to the display panel 100 together, which is also the scope of the invention.

Step 206 and step 208 of the driving process 20 respectively have the first reception unit 1042_1 and the second reception unit 1042_2 of the second reception module 1042 receive the input signal SIN (or the corresponding transistors of the first reception unit 1042_1 and the second reception unit 1042_2 are skipped within the same period for not receiving the input signal SIN), such that the display information of the embodiment can be adaptively modified/adjusted to be applied to the different display device resolutions. Certainly, those skilled in the art can modify/adjust sequences of receiving the input signal SIN of the first reception unit 1042_1 and the second reception unit 1042_2. Alternatively, operations of step 206 can also be modified to have the second reception module 1042 and the first reception module 1042 simultaneously receive the input signal SIN, and the two reception units of the second reception module 1042 are operated to simultaneously receive the input signal SIN rather than the two respective receptions of the input signal SIN for the two reception units, which is also in the scope of the invention. After the third reception module 1044 has received the input signal SIN, the reception of input signal SIN is finished.

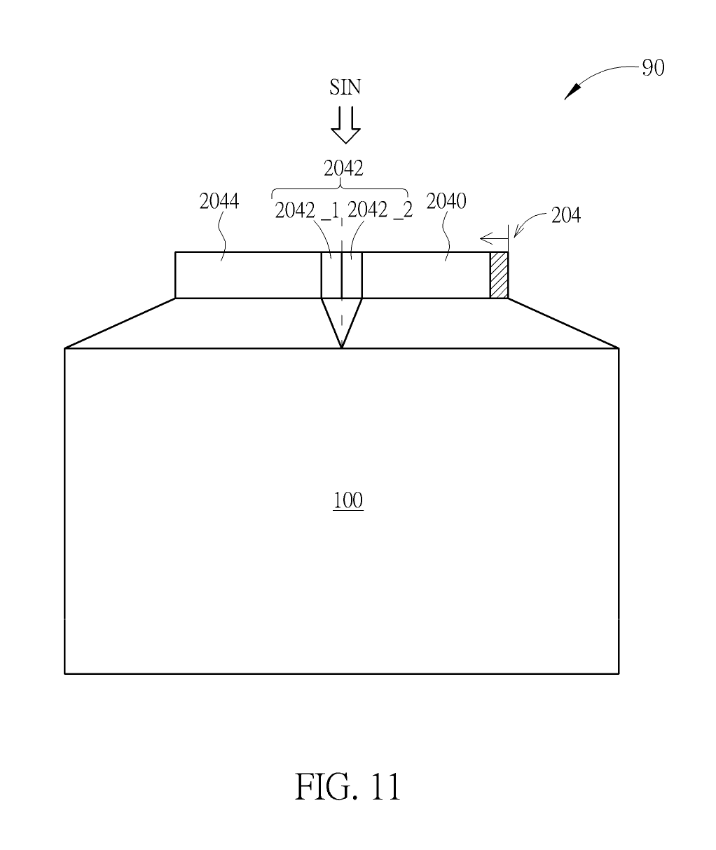

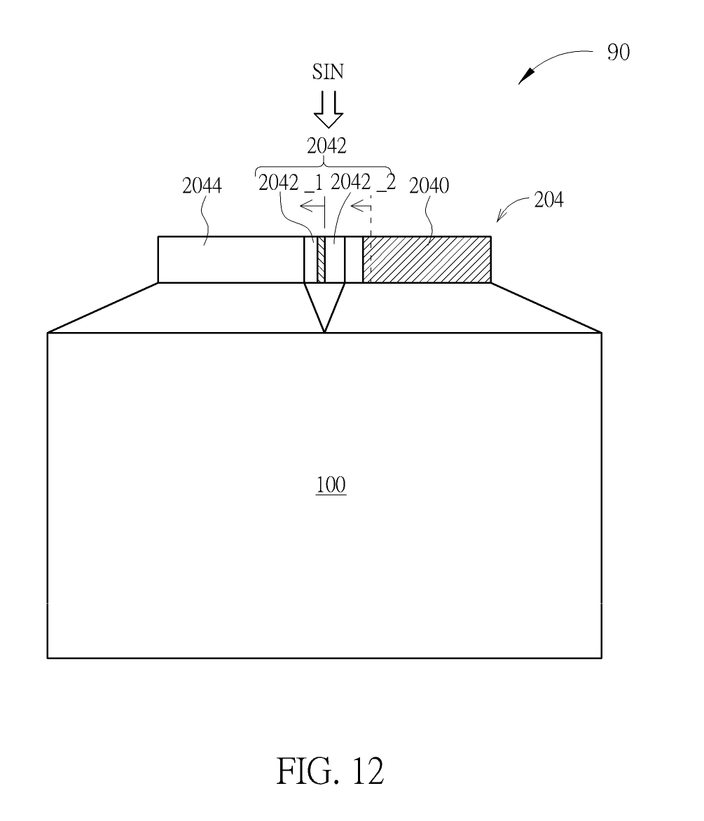

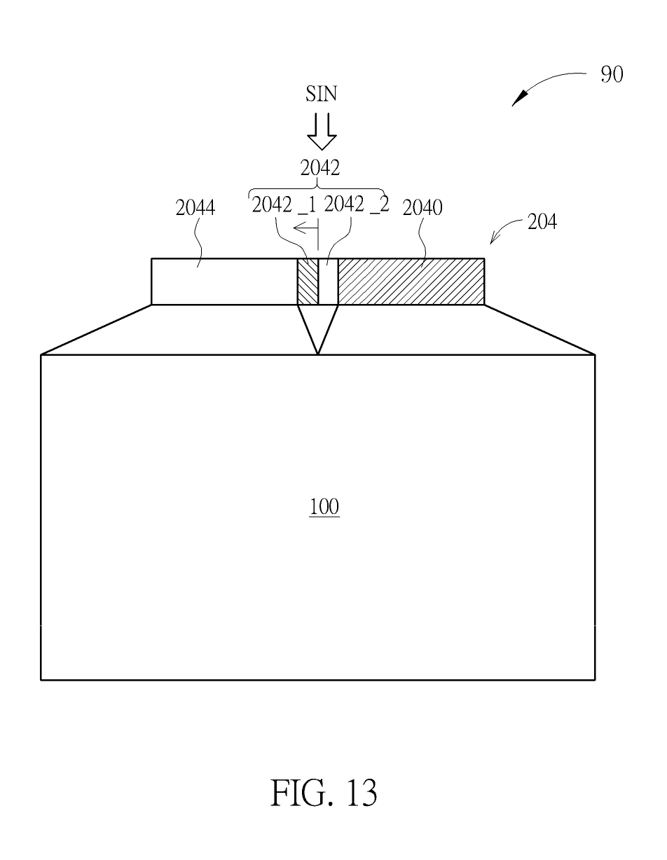

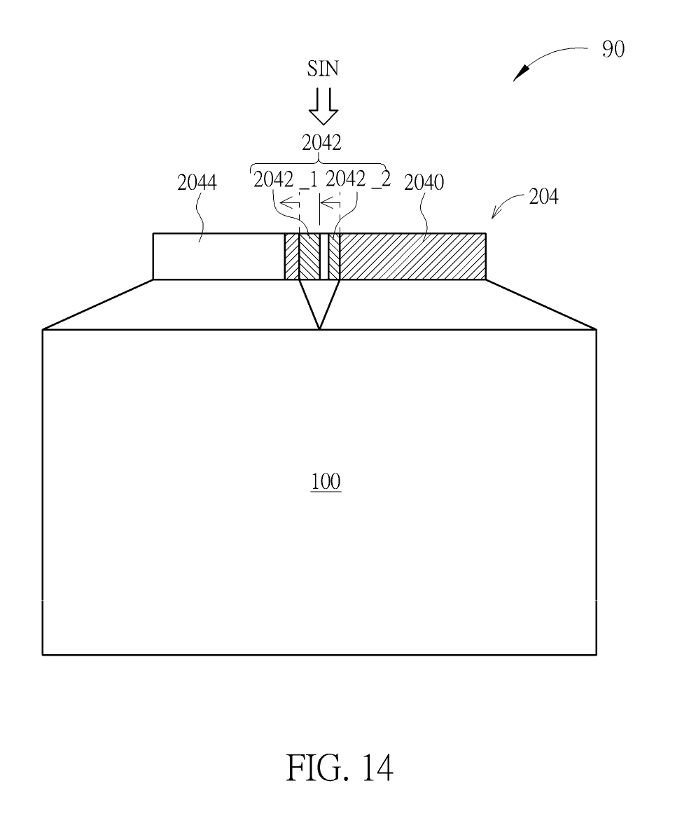

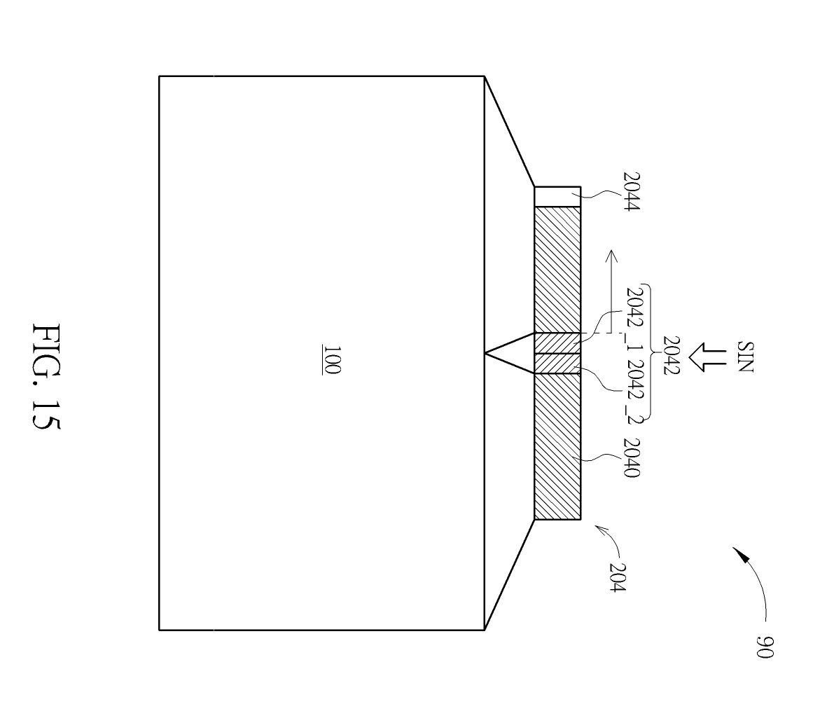

FIG. 11 illustrates a schematic diagram of another display device 90 according to an embodiment of the invention. As shown in FIG. 11, the display device 90 is similar to the display device 30 shown in FIG. 3, the difference is that the display device 90 has the source driving circuit 204 reversely disposed in comparison with the source driving circuit 104 in FIG. 3, i.e. the source driving circuit 204 of the display device 90 sequentially comprises the third reception module 2044, the second reception module 2042, comprising the first reception unit 2042_1 and the second reception module 2042_2, and the first reception module 2040 from left to right. The other composition elements/modules of the display device 90 are similar to the ones of the display device 30 with similar operations, which is not described hereinafter for brevity. Under such circumstances, the display device 90 can be applied to each step of the driving process 20, and descriptive operations thereof are shown in FIG. 11 to FIG. 15 for illustration, i.e. step 204 corresponding to step 204, FIG. 12 and FIG. 13 corresponding to step 206, FIG. 14 and FIG. 15 corresponding to step 208. Since detailed operations shown in FIG. 11 to FIG. 15 can be referred to embodiments shown in FIG. 5 to FIG. 10, they are not described herein after for brevity.

Simply, the embodiment of the invention drives/triggers the plurality of transistors disposed in different zones at different periods, such that the input signal is inputted into the source driving circuit. Also, the number of the transistors of the second reception module (i.e. the number of the dummy channels) can be adaptively adjusted/modified to comply with different display device resolutions for displaying the display information, which contributes the advantage that the conventional jumper wires for realizing the short circuit of connections of the transistors can be neglected to switch the display device between complex display device resolutions. Also, the embodiment of the invention further comprises a fourth period disposed between the second period and third period. In the fourth period, the plurality of transistors of the first reception module and the second reception module are sequentially driven to receive the input signal SIN or the plurality of transistors of the first reception module and the second reception module are skipped. Alternatively, the plurality of transistors of the second reception module and the third reception module are sequentially driven to receive the input signal SIN, or the plurality of transistors of the second reception module and the third reception module are skipped. Additionally, the first period, the second period and the third (also considering the fourth period) can be divided into a plurality of sub-periods, such that the first reception module, the second reception module and the third reception module can synchronously/asynchronously receive the input signal or the corresponding transistors can be skipped, which is also in the scope of the invention.

Preferably, the embodiment of the invention further comprises a determination module (not shown in the figure) to be coupled to the control chip (or the source driving circuit), and the determination module predetermines the display device resolution of the input signal to adaptively control/adjust the number of the transistors of the second reception module. Besides, the previous embodiments teaches that all of the plurality of transistors of the second reception module (i.e. the dummy channels) can be designed to receive the input signal or to be skipped for not receiving the input signal. Certainly, those skilled in the art can adaptively divide all the plurality of the transistors of the second reception module into two transistor groups (or more than two if possible), such that one transistor group receives the input signal, and the other transistor group is skipped for not receiving the input signal, to adaptively integrate/select the two realizations for different transistor groups, which is also in the scope of the invention.

In summary, the embodiments of the invention provide a driving method and display device for controlling the source driving circuit. At different periods, the first reception module, the second reception module and the third reception module of the source driving circuit respectively receive the input signal corresponding to the display information, such that the display device can be switched between different display device resolutions and avoid utilization of the jumper wires for realizing the short circuit of the connections of the plurality of transistors of the source driving circuit, so as to operate the display device with adjustable display device resolutions. Thus, in comparison with the prior art, the number of the plurality of transistors of the source driving circuit (i.e. the number of the dummy channels) can be adaptively adjusted/modified to dynamically control the driving periods of the plurality of transistors of the source driving circuit, so as to improve the application range of the display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a source driving circuit, which is utilized in a display device and comprises a first reception module, a second reception module and a third reception module, the method comprising:
receiving an input signal by the first reception module at a first period;
receiving the input signal by the first reception module and the second reception module at a second period after the first period;
receiving the input signal by the second reception module and the third reception module at a third period after the second period; and
outputting the input signal received by the first reception module, the second reception module and the third reception module to a display panel after the third reception module has received the input signal;
wherein the second reception module is disposed between the first reception module and the third reception module, each of the first reception module, the second reception module and the third reception module comprises a plurality of transistors to receive the input signal, and the input signal corresponds to a display information of the display device.

2. The method of claim 1, wherein a total number of the plurality of transistors of the first reception module, the second reception module and the third reception module is an original display device resolution, and a total number of the plurality of transistors of the first reception module and the third reception module is a corrective display device resolution, wherein a number of the transistors of the second reception module is a dummy channel number.

3. The method of claim 1, wherein the first period is a period for driving some transistors of the first reception module, the second period is a period for driving the other transistors of the first reception module and some transistors of the second reception module, and the third period is a period for driving the other transistors of the second reception module and all the plurality of transistors of the third reception module.

4. The method of claim 1, wherein the plurality of transistors of the first reception module have not finished reception of the input signal after the first period and before the second period, and the plurality of transistors of the first reception module have finished reception of the input signal after the second period and before the third period.

5. The method of claim 1, wherein some transistors of the first reception module and some transistors of the second reception module synchronously receive the input signal within the second period, and some transistors of the second reception module and some transistors of the third reception module synchronously receive the input signal within the third period.

6. The method of claim 1, wherein the plurality of transistors of the first reception module receive the input signal and a number, being equal to a number of the transistors of the first reception module receiving the input signal, of transistors of the second reception module are skipped without receiving the input signal within the second period, and the plurality of transistors of the third reception module receive the input signal and a number, being equal to a number of the transistors of the third reception module receiving the input signal, of the transistors of the second reception module are skipped without receiving the input signal within the third period.

7. The method of claim 1, wherein both the plurality of transistors of the second reception module and the third reception module have received the input signal after the third period, or the plurality of transistors of the third reception module have received the input signal and the plurality of transistors of the second reception module have been skipped without receiving the input signal after the third period.

8. The method of claim 1, further comprising at least a fourth period being configured between the second period and the third period, and some transistors of the first reception module and some transistors of the second reception module are sequentially driven to receive the input signal within the fourth period, or some transistors of the second reception module and some transistors of the third reception module are sequentially driven to receive the input signal within the fourth period.

9. The method of claim 1, wherein the second reception module further comprises a first reception unit and a second reception unit, and the first reception unit receives the input signal within the second period and the second reception unit receives the input signal within the third period.

10. The method of claim 1, wherein the source driving circuit sequentially disposes the first reception module, the second reception module and the third reception module from left to right, and the plurality of transistors of the first reception module, the second reception module and third reception module sequentially receive the input signal from left to right; or the source driving circuit sequentially disposes the first reception module, the second reception module and the third reception module from right to left, and the plurality of transistors of the first reception module, the second reception module and third reception module sequentially receive the input signal from right to left.

11. A control chip, which is coupled to a gate driving circuit and a source driving circuit, the source driving chip comprises a first reception module, a second reception module and a third reception module, the control chip comprising:
a storage device, for storing a programming code, wherein the programming code is utilized to instruct a method for controlling the source driving circuit, the method comprising:
receiving an input signal by the first reception module at a first period;
receiving the input signal by the first reception module and the second reception module at a second period after the first period;
receiving the input signal by the second reception module and the third reception module at a third period after the second period; and
outputting the input signal received by the first reception module, the second reception module and the third reception module to a display panel after the third reception module has received the input signal;
wherein the second reception module is surrounded by the first reception module and the third reception module, each of the first reception module, the second reception module and the third reception module comprises a plurality of transistors to receive the input signal, and the input signal corresponds to a display information of a display device.

12. The control chip of claim 11, wherein a total number of the plurality of transistors of the first reception module, the second reception module and the third reception module is an original display device resolution, and a total number of the plurality of transistors of the first reception module and the third reception module is a corrective display device resolution, wherein a number of the transistors of the second reception module is a dummy channel number.

13. The control chip of claim 11, wherein the first period is a period for driving some transistors of the first reception module, the second period is a period for driving the other transistors of the first reception module and some transistors of the second reception module, and the third period is a period for driving the other transistors of the second reception module and all the plurality of transistors of the third reception module.

14. The control chip of claim 11, wherein the method further comprises the plurality of transistors of the first reception module have not finished reception of the input signal after the first period and before the second period, and the plurality of transistors of the first reception module have finished reception of the input signal after the second period and before the third period.

15. The control chip of claim 11, wherein the method further comprises some transistors of the first reception module and some transistors of the second reception module synchronously receive the input signal within the second period, and some transistors of the second reception module and some transistors of the third reception module synchronously receive the input signal within the third period.

16. The control chip of claim 11, wherein the method further comprises the plurality of transistors of the first reception module receive the input signal and a number, being equal to a number of the transistors of the first reception module receiving the input signal, of transistors of the second reception module are skipped without receiving the input signal within the second period, and the plurality of transistors of the third reception module receive the input signal and a number, being equal to a number of the transistors of the third reception module receiving the input signal, of the transistors of the second reception module are skipped without receiving the input signal within the third period.

17. The control chip of claim 11, wherein the method further comprises both the plurality of transistors of the second reception module and the third reception module have received the input signal after the third period, or the plurality of transistors of the third reception module have received the input signal and the plurality of transistors of the second reception module have been skipped without receiving the input signal after the third period.

18. The control chip of claim 11, further comprising at least a fourth period being configured between the second period and the third period, and some transistors of the first reception module and some transistors of the second reception module are sequentially driven to receive the input signal within the fourth period, or some transistors of the second reception module and some transistors of the third reception module are sequentially driven to receive the input signal within the fourth period.

19. The control chip of claim 11, wherein the second reception module further comprises a first reception unit and a second reception unit, and the first reception unit receives the input signal within the second period and the second reception unit receives the input signal within the third period.

20. The control chip of claim 11, wherein the source driving circuit sequentially disposes the first reception module, the second reception module and the third reception module from left to right, and the plurality of transistors of the first reception module, the second reception module and third reception module sequentially receive the input signal from left to right; or the source driving circuit sequentially disposes the first reception module, the second reception module and the third reception module from right to left, and the plurality of transistors of the first reception module, the second reception module and third reception module sequentially receive the input signal from right to left.

21. A display device, comprising:
a display panel;
a gate driving circuit, coupled to the display panel;
a source driving circuit, coupled to the display panel, comprising a first reception module, a second reception module and a third reception module; and
a control chip, coupled to the gate driving circuit and the source driving circuit, comprising a storage device for storing a programming code, wherein the programming code is utilized to instruct a method for controlling the source driving circuit, the method comprising:
receiving an input signal by the first reception module at a first period;
receiving the input signal by the first reception module and the second reception module at a second period after the first period;
receiving the input signal by the second reception module and the third reception module at a third period after the second period; and
outputting the input signal received by the first reception module, the second reception module and the third reception module to the display panel after the third reception module has received the input signal;
wherein the second reception module is surrounded by the first reception module and the third reception module, each of the first reception module, the second reception module and the third reception module comprises a plurality of transistors to receive the input signal, and the input signal corresponds to a display information of the display device.

22. The display device of claim 21, wherein a total number of the plurality of transistors of the first reception module, the second reception module and the third reception module is an original display device resolution, and a total number of the plurality of transistors of the first reception module and the third reception module is a corrective display device resolution, wherein a number of the transistors of the second reception module is a dummy channel number.

23. The display device of claim 21, wherein the first period is a period for driving some transistors of the first reception module, the second period is a period for driving the other transistors of the first reception module and some transistors of the second reception module, and the third period is a period for driving the other transistors of the second reception module and all the plurality of transistors of the third reception module.

24. The display device of claim 21, wherein the method further comprises the plurality of transistors of the first reception module have not finished reception of the input signal after the first period and before the second period, and the plurality of transistors of the first reception module have finished reception of the input signal after the second period and before the third period.

25. The display device of claim 21, wherein the method further comprises some transistors of the first reception module and some transistors of the second reception module synchronously receive the input signal within the second period, and some transistors of the second reception module and some transistors of the third reception module synchronously receive the input signal within the third period.

26. The display device of claim 21, wherein the method further comprises the plurality of transistors of the first reception module receive the input signal and a number, being equal to a number of the transistors of the first reception module receiving the input signal, of transistors of the second reception module are skipped without receiving the input signal within the second period, and the plurality of transistors of the third reception module receive the input signal and a number, being equal to a number of the transistors of the third reception module receiving the input signal, of the transistors of the second reception module are skipped without receiving the input signal within the third period.

27. The display device of claim 21, wherein the method further comprises both the plurality of transistors of the second reception module and the third reception module have received the input signal after the third period, or the plurality of transistors of the third reception module have received the input signal and the plurality of transistors of the second reception module have been skipped without receiving the input signal after the third period.

28. The display device of claim 21, further comprising at least a fourth period being configured between the second period and the third period, and some transistors of the first reception module and some transistors of the second reception module are sequentially driven to receive the input signal within the fourth period, or some transistors of the second reception module and some transistors of the third reception module are sequentially driven to receive the input signal within the fourth period.

29. The display device of claim 21, wherein the second reception module further comprises a first reception unit and a second reception unit, and the first reception unit receives the input signal within the second period and the second reception unit receives the input signal within the third period.

30. The display device of claim 21, wherein the source driving circuit sequentially disposes the first reception module, the second reception module and the third reception module from left to right, and the plurality of transistors of the first reception module, the second reception module and third reception module sequentially receive the input signal from left to right; or the source driving circuit sequentially disposes the first reception module, the second reception module and the third reception module from right to left, and the plurality of transistors of the first reception module, the second reception module and third reception module sequentially receive the input signal from right to left.
